(19) United States
(12) Patent Application Publication
(10) Pub. No.: US 2020/0186080 A1
(43) Pub. Date: Jun. 11, 2020

(54) Robot for Cleaning Photovoltaic Panel and Method for Controlling the Same

(71) Applicant: SUNGROW POWER SUPPLY CO., LTD., Hefei (CN)

(72) Inventors: Lichun ZHU, Hefei (CN); Jiapeng ZHU, Hefei (CN); Yaobang WANG, Hefei (CN); Wei LI, Hefei (CN); Zhisheng JIN, Hefei (CN)

(73) Assignee: SUNGROW POWER SUPPLY CO., LTD., Hefei (CN)

(21) Appl. No.: 16/579,703

(22) Filed: Sep. 23, 2019

(30) Foreign Application Priority Data
Dec. 6, 2018 (CN) 201811487570.2

(51) Int. Cl. H02S 40/10; G05D 1/00; B25J 11/00

(52) U.S. Cl. CPC H02S 40/10; B25J 11/0085; G05D 1/0088

(57) ABSTRACT

A robot for cleaning a photovoltaic panel and a method for controlling the robot. The robot is driven by a motor to travel along a left boarder and a right boarder of the photovoltaic panel, and the robot is provided with a first control unit and a distance sensor. The distance sensor is installed on a sidewall of the robot, faces a sidewall of the photovoltaic panel, and is configured to measure a distance between the distance sensor and the sidewall of the photovoltaic panel. The sidewalls are left sidewalls or right sidewalls. The first control unit is configured to determine that a measurement for the distance that is fed back by the distance sensor exceeds a first preset range, and determine that the robot deviates. Thereby, it is detected in real time whether the robot deviates, facilitating timely correcting deviation.

The present application claims priority to Chinese Patent Application No. 201811487570.2, titled “ROBOT FOR CLEANING PHOTOVOLTAIC PANEL AND METHOD FOR CONTROLLING THE SAME”, filed on Dec. 6, 2018 with the China National Intellectual Property Administration, which is incorporated herein by reference in its entirety.

### FIELD

The present disclosure relates to the technical field of automatic control, and in particular, to a robot for cleaning a photovoltaic panel and a method for controlling the robot.

### BACKGROUND

Driven by a motor, a robot for cleaning a photovoltaic panel travels along a left boarder and a right boarder of the photovoltaic panel, as shown in FIG. 1. The robot for cleaning the photovoltaic panel inevitably deviates in travelling, as shown in FIG. 2.

A left edge and a right edge of the robot for cleaning the photovoltaic panel extend downward in a vertical direction to form a left sidewall and a right sidewall, respectively. Two limiting apparatuses (for example, limiting wheels denoted by “1” in FIG. 2) are installed at a front part and a rear part, respectively, on each of the left sidewall and the right sidewall. The limiting apparatuses are configured to keep a travelling direction (denoted by arrows in FIGS. 1 and 2) of the robot before and after deviation unchanged, thereby preventing the robot from falling off from the photovoltaic panel. There are problems that a travelling resistance of the robot is increased and an obstacle-crossing ability of the robot is reduced.

### SUMMARY

In view of the above, a robot for cleaning a photovoltaic panel and a method for controlling the robot are provided according to embodiments of the present disclosure, so as to detect in real time whether the robot for cleaning the photovoltaic panel deviates and timely correct deviation.

A robot for cleaning a photovoltaic panel is provided, where the robot is driven by a motor to travel along a left boarder and a right boarder of the photovoltaic panel, and the robot is provided with a first control unit and a distance sensor;

the distance sensor is installed on a left sidewall of the robot, the distance sensor faces a left sidewall of the photovoltaic panel, and the distance sensor is configured to measure a distance between the distance sensor and the left sidewall of the photovoltaic panel; or, the distance sensor is installed on a right sidewall of the robot, the distance sensor faces a right sidewall of the photovoltaic panel, and the distance sensor is configured to measure a distance between the distance sensor and the right sidewall of the photovoltaic panel; and

the first control unit is configured to determine that a measurement for the distance that is fed back by the distance sensor exceeds a first preset range, and determine that the robot deviates.

Optionally, the motor includes a left-side motor and a right-side motor that drive the robot independently, the left-side motor drives a travelling wheel at a left side of a chassis of the robot, and the right-side motor drives a travelling wheel at a right side of the chassis of the robot; and

the first control unit is further configured to adjust a speed of the right-side motor or the left-side motor based on the measurement fed back by the distance sensor, for automatically correcting deviation.

A robot for cleaning a photovoltaic panel is provided, where the robot is driven by a motor to travel along a left boarder and a right boarder of the photovoltaic panel, and the robot is provided with a second control unit and two distance sensors;

the two distance sensors are installed on a left sidewall of the robot, the two distance sensors face a left sidewall of the photovoltaic panel, the two distance sensors are symmetrically arranged in a travelling direction of the robot for cleaning the photovoltaic panel, and each of the two distance sensors is configured to measure a distance between said distance sensor and the left sidewall of the photovoltaic panel; or, the two distance sensors are installed on a right sidewall of the robot, the two distance sensors face a right sidewall of the photovoltaic panel, the two distance sensors are symmetrically arranged in a travelling direction of the robot, and each of the two distance sensors is configured to measure a distance between said distance sensor and the right sidewall of the photovoltaic panel; and the second control unit is configured to determine that a difference between measurements for the distance that are fed back by the two distance sensors exceeds a second preset range, and determine that the robot deviates.

Optionally, the motor includes a left-side motor and a right-side motor that drive the robot independently, the left-side motor drives a travelling wheel at a left side of a chassis of the robot, and the right-side motor drives a travelling wheel at a right side of the chassis of the robot; and

the second control unit is further configured to adjust a speed of the right-side motor or the left-side motor based on the difference between the measurements fed back by the two distance sensors, for automatically correcting deviation.

Optionally, the speed of the right-side motor or the left-side motor is adjusted by using a subsection control algorithm.

Optionally, the distance sensor is an ultrasonic distance sensor or an infrared distance sensor.

A method for controlling a robot for cleaning a photovoltaic panel is provided, where the method is applied to the aforementioned robot provided with the first control unit and the distance sensor, and the method includes:

determining that the measurement fed back by the distance sensor exceeds the first preset range; and

determining that the robot deviates.

Optionally, the motor includes a left-side motor and a right-side motor that drive the robot independently, the left-side motor drives a travelling wheel at a left side of a chassis of the robot, and the right-side motor drives a travelling wheel at a right side of the chassis of the robot; and

after determining that the robot deviates, the method further includes:

adjusting the speed of the right-side motor or the left-side motor based on the measurement fed back by the distance sensor, for automatically correcting deviation.

A method for controlling a robot for cleaning a photovoltaic panel is provided, where the method is applied to the aforementioned robot provided with the second control unit and the two distance sensors, the method includes:

determining that the difference between the measurements fed back by the two distance sensors exceeds the second preset range; and

determining that the robot deviates.

Optionally, the motor includes a left-side motor and a right-side motor that drive the robot independently, the left-side motor drives a travelling wheel at a left side of a chassis of the robot, and the right-side motor drives a travelling wheel at a right side of the chassis of the robot; and

after determining that the robot deviates, the method further includes:

adjusting the speed of the right-side motor or the left-side motor based on the difference between the measurements fed back by the two distance sensors, for automatically correcting deviation.

It can be seen from the above technical solution, once the robot for cleaning the photovoltaic panel deviates, the distance between the distance sensor and the left sidewall (or the right sidewall) of the photovoltaic panel changes. Therefore, it is determined whether the robot for cleaning the photovoltaic panel deviates by analyzing a change of the distance according to embodiments of the present disclosure. Thereby, it is convenient for working personnel to know in real time whether there is deviation and timely correct the deviation.

### BRIEF DESCRIPTION OF THE DRAWINGS

For clearer illustration of the technical solutions according to embodiments of the present disclosure or conventional techniques, hereinafter are briefly described the drawings to be applied in embodiments of the present disclosure or conventional techniques. Apparently, the drawings in the following descriptions are only some embodiments of the present disclosure, and other drawings may be obtained by those skilled in the art based on the provided drawings without creative efforts.

FIG. 1 is a schematic top view of a robot for cleaning a photovoltaic panel without deviation;

FIG. 2 is a schematic top view of a robot for cleaning a photovoltaic panel with deviation;

FIG. 3 is a schematic top view of a robot for cleaning a photovoltaic panel with deviation according to an embodiment of the present disclosure;

FIG. 4 is a schematic top view of a robot for cleaning a photovoltaic panel with deviation according to an embodiment of the present disclosure;

FIG. 5 is a flowchart of a method for controlling a robot for cleaning a photovoltaic panel according to an embodiment of the present disclosure;

FIG. 6 is another flowchart of a method for controlling a robot for cleaning a photovoltaic panel according to an embodiment of the present disclosure;

FIG. 7 is another flowchart of a method for controlling a robot for cleaning a photovoltaic panel according to an embodiment of the present disclosure; and

FIG. 8 is another flowchart of a method for controlling a robot for cleaning a photovoltaic panel according to an embodiment of the present disclosure.

### DETAILED DESCRIPTION OF EMBODIMENTS

Hereinafter technical solutions in embodiments of the present disclosure are described clearly and completely in conjunction with the drawings in embodiments of the present closure. Apparently, the described embodiments are only some rather than all of the embodiments of the present disclosure. Any other embodiments obtained based on the embodiments of the present disclosure by those skilled in the art without any creative effort fall within the scope of protection of the present disclosure.

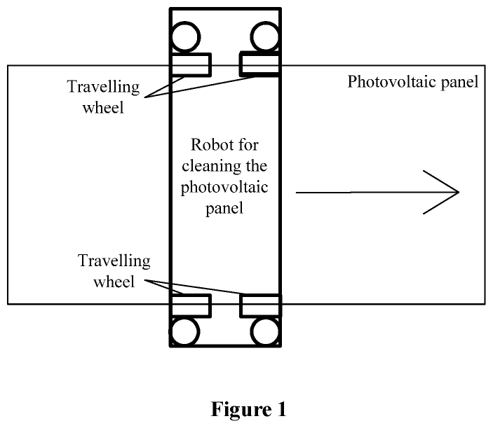

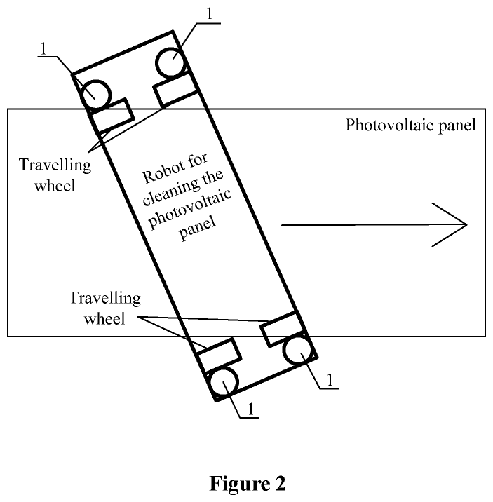

To facilitate appreciation, the directional terms such as “left”, “right”, “front” and “rear” are defined with respect to a forwarding direction of a robot for cleaning a photovoltaic panel in embodiments of the present disclosure. For example, in FIGS. 1 to 4, the robot travels in a direction indicated by an arrow pointing to right. Thereby, a “left” side indicates an upper side in the paper surface, and a “right” side indicates a lower side in the paper surface. Those skilled in the art can appreciate that a same directional term may refer to different directions in a case the traveling direction of the robot are drawn in different manners.

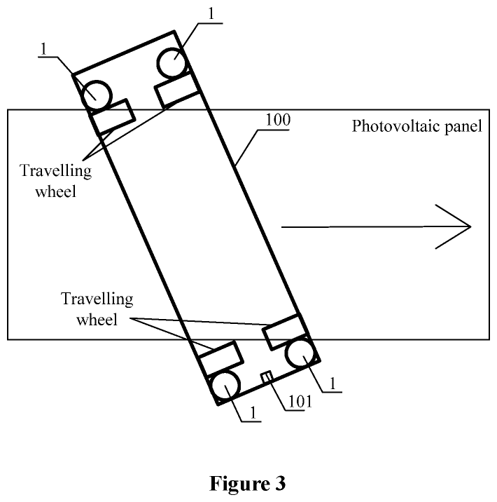

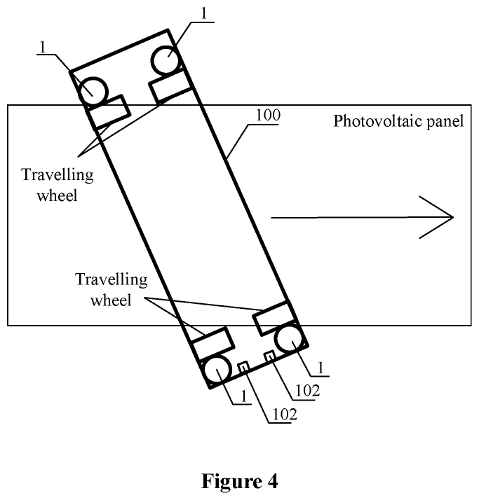

An improved robot for cleaning a photovoltaic panel is obtained according to an embodiment of the present disclosure. A top view of the robot for cleaning the photovoltaic panel is as shown in FIG. 3 or FIG. 4, which is described hereinafter.

Four travelling wheels are installed on a chassis of a robot 100 for cleaning a photovoltaic panel. It is appreciated that more travelling wheels may be installed in case of the chassis of the robot 100 being too wide or too long. Inevitably, the robot 100 deviates in travelling. For example, the robot 100 is driven by independent motors at two sides, of which a left-side motor drives a travelling wheel that travels along a left boarder of the photovoltaic panel, and a right-side motor drives a travelling wheel that travels along a right boarder of the photovoltaic panel. When travelling along a straight line, a cumulative error due to an inconsistency between speeds of the motors at two sides causes the robot 100 to deviate.

A left edge and a right edge of the robot 100 extend downward in a vertical direction to form a left sidewall and a right sidewall, respectively. Two limiting apparatuses (for example, limiting wheels denoted by “1” in FIG. 3) are installed at a front part and a rear part, respectively, on each of the left sidewall and the right sidewall. The limiting apparatuses keep a travelling direction of the robot 100 before and after deviation unchanged, thereby preventing the robot 100 from falling off from the photovoltaic panel. Nevertheless, there are problems that a travelling resistance of the robot is increased and an obstacle-crossing ability of the robot is reduced.

In order to facilitate correcting a travelling posture of the robot 100 in real time, a first control unit and a distance sensor 101 are provided to the robot 100 according to an embodiment of the present disclosure, as shown in FIG. 3. The distance sensor 101 is installed on the left sidewall (or the right sidewall) of the robot 100, and faces the left sidewall (or the right sidewall) of the photovoltaic panel. The distance sensor is configured to measure a distance between the distance sensor 101 and the left sidewall (or the right sidewall) of the photovoltaic panel.

The robot 100 driven by a motor travels along the left and right boarders of the photovoltaic panel. In such process, a distance between the left sidewall (or the right sidewall) of the photovoltaic panel and any point, which is on the left sidewall (or the right sidewall) of the robot 100 and faces the left sidewall (or the right sidewall) of the photovoltaic panel, is a fixed distance a, in a case that the robot 100 does not deviate. The distance between such point and the left sidewall (or the right sidewall) of the photovoltaic panel changes, in a case that the robot 100 deviates. The larger the distance changes, the larger a deviation angle is. The first control unit is configured to determine whether a measurement for the distance that is fed back by the distance sensor 101 exceeds a first preset range. In case of a positive determination, the distance from the distance sensor 101 to the left sidewall (or the right sidewall) of the photovoltaic panel is determined to deviate from the fixed distance a. In such case, it is determined that the robot 100 deviates. Thereby, it is convenient for working personnel to know in real time whether there is deviation and timely correct the deviation.

Optionally, the robot 100 is driven by the two independent motors at two sides, and a speed of a corresponding motor is adjusted to achieve automatic deviation correction. For example, a speed of a left-side motor is reduced or a speed of a right-side motor is increased in a case that a left side of the robot 100 leads in deviation, and the speed of the right-side motor is reduced or the speed of the left-side motor is increased in a case that a right side of the robot 100 leads in deviation. Correspondingly, the first control unit is further configured to adjust the speed of the corresponding motor based on the measurement fed back by the distance sensor, for automatically correcting deviation, in a case that the robot 100 deviates.

It should be noted that magnitude of the measured distance fed back by the distance sensor 101 reflects both whether there is deviation and magnitude of the deviation, and does not reflect a direction of the deviation. Namely, it is not reflected whether a left side or a right side of the robot 100 leads in the deviation. By default in deviation correction, the left side of the robot 100 may be considered to lead in the deviation as the first control unit automatically corrects the deviation. In a case that the measurement fed back by the distance sensor 101 gradually approaches the fixed value a under the deviation correction, it indicates that the default deviating direction is an actual deviating direction, and the deviation correction of the deviation is continued. In a case that the measurement fed back by the distance sensor 101 deviates more from the fixed value a under the deviation correction, it indicates that the default deviating direction is opposite to an actual deviating direction, and the deviation correction is re-performed for a situation that the right side of the robot 100 leads in the deviation. It is appreciated that in the deviation correction, the right side of the robot 100 may be considered to lead in the deviation by default, as the first control unit automatically corrects the deviation. In a case that the measurement fed back by the distance sensor 101 deviates more from the fixed value a under the deviation correction, the deviation correction is re-performed for a situation that the left side of the robot 100 leads in the deviation.

Optionally, the left sidewall (or the right sidewall) of the robot 100 has a rectangular surface, and the distance sensor 101 is preferably installed at a position in a bisector of a lower edge of the left sidewall (or the right sidewall) of the robot 100 according to one embodiment of the present disclosure. Compared with other positions, a distance between such position and the left sidewall (or the right sidewall) of the photovoltaic panel changes more under a same deviation angle. A change of measurement from the distance sensor 101 is large, facilitating detection.

Alternatively, a second control unit and two distance sensors 102 may be provided to the robot 100, as shown in FIG. 4, so as to facilitate the real-time correction of the travelling posture of the robot 100. The two distance sensors are installed on a left sidewall (or a right wall) of the robot 100, and face the left sidewall (or the right sidewall) of the photovoltaic panel. The two distance sensors are symmetrically arranged on the left sidewall (or the right sidewall) of the robot 100 in a travelling direction of the robot 100, and each is configured to measure a distance between such distance sensor and the left sidewall (or the right sidewall) of the photovoltaic panel. As an example, the left sidewall (or the right sidewall) of the robot 100 has a rectangular surface, and the two distance sensors being symmetrically arranged on the left sidewall (or the right sidewall) of the robot 100 in the travelling direction of the robot 100 may be appreciated as follows. A line connecting the two distance sensors is parallel to a lower edge of the left sidewall (or right sidewall) of the robot 100, and a distance between an installation position of each distance sensor and a bisector of the lower edge of the left sidewall (or right sidewall) of the robot 100 is same.

The robot 100 driven by a motor travels along left and right boarders of the photovoltaic panel. In such process, a difference between measurements from the two distance sensors is zero, in a case that the robot 100 does not deviate. Measurements from the two distance sensors change in opposite directions, in a case that the robot 100 deviates. Namely, the difference between measurements from the two distance sensors changes. The larger an absolute value of the difference between the measurements from the two distance sensors is, the larger the deviation angle is. In addition, a direction of the deviation is reflected by comparing magnitude of the measurements from the two distance sensors. The second control unit is configured to determine whether the difference between the measurements fed back by the two distance sensors exceeds a second preset range. In case of a positive determination, it is determined that the difference between the measurements fed back by the two distance sensors is no longer zero. In such case, it is determined that the robot 100 deviates. Thereby, it is convenient for working personnel to know in real time whether there is deviation and timely correct the deviation.

Optionally, the robot 100 is driven by two independent motors at two sides. The second control unit is further configured to adjust a speed of a corresponding motor based on the difference between the measurements fed back by the two distance sensors, for automatically correcting deviation, in a case that the robot 100 deviates. The direction of the deviation is reflected by comparing magnitude of the measurements from the two distance sensors. As an example, the two distance sensors are installed on the right sidewall of the robot 100. In a case that a measurement from a front distance sensor is larger than that from a rear distance sensor, it indicates that a left side of the robot 100 leads in the deviation. In a case that a measurement from a rear distance sensor is larger than that from a front distance sensor, it indicates that a right side of the robot 100 leads in the deviation. Therefore, the second control unit is configured to correct deviation directly based on an actual deviating direction of the robot 100, achieving a faster deviation correction than the technical solution corresponding to FIG. 3. In addition, a feedback from the distance sensors may deviate from an actual distance due to environmental factors such as light, haze and dust, and there may be misjudgment in a case that the deviating is determined based on direct feedback. An influence of the environmental factors can be minimized by determining the deviation based on the difference between the measurements fed back by the two distance sensors.

Optionally, in any aforementioned technical solution, a subsection control algorithm may be applied to adjust the speed of the motor in deviation correction, for example, a subsection proportional (P) algorithm or a subsection proportional-differential (PD) algorithm may be applied. Taking the subsection proportional (P) algorithm as an example, magnitude of a proportional gain is set based on magnitude of the deviation angle. The larger the deviation angle is, the larger the proportional gain is set, and the smaller the deviation angle is, the smaller the proportional gain is set. In such way, the subsection proportional deviation correction is implemented. It is prevented that in a corresponding speed subsection, an adjustment oscillates due to the proportional gain being set too large, or an adjustment costs too much time due to the proportional gain being setting too small.

Optionally, in any aforementioned technical solution, the distance sensor may be an ultrasonic distance sensor or an infrared distance sensor. The present disclosure is not limited thereto.

It should be noted that the distance sensor described in any aforementioned technical solution may be a single independent electronic component for a distance sensor, or a collection of multiple electronic components for distance sensors. The measurement from the distance sensor refers to an average of measurements from the multiple electronic components in case of the latter.

It can be seen from the above description, once the robot for cleaning the photovoltaic panel deviates, the distance between the distance sensor and the left sidewall (or the right sidewall) of the photovoltaic panel changes. Therefore, it is determined whether the robot for cleaning the photovoltaic panel deviates by analyzing a change of the distance according to embodiments of the present disclosure. Thereby, it is convenient for working personnel to know in real time whether there is deviation and timely correct the deviation.

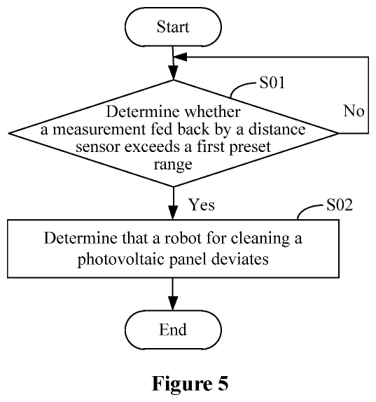

Corresponding to the embodiment as shown in FIG. 3, a method for controlling robot for cleaning a photovoltaic panel is provided according to an embodiment of the present disclosure, as shown in FIG. 5. The method includes steps S01 and S02.

In step S01, it is determined whether a measurement fed back by a distance sensor of a robot for cleaning a photovoltaic panel exceeds a first preset range. The method goes to step S02 in case of a positive determination, and repeats step S01 in case of a negative determination.

In step S02, it is determined that the robot deviates.

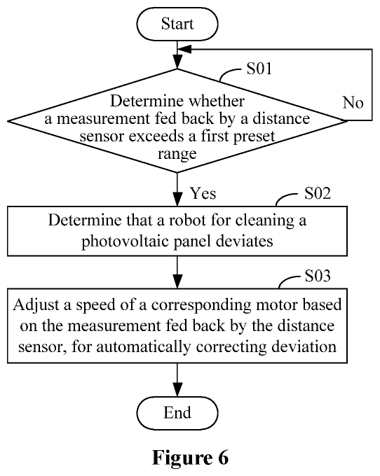

Optionally, the robot is driven by two independent motors at two sides. A left-side motor drives a travelling wheel that is on a left side of a chassis of the robot. A right-side motor drives a travelling wheel that is on a right side of the chassis of the robot. Correspondingly, as shown in FIG. 6, a method for controlling a robot for cleaning a photovoltaic panel is further provided according to an embodiment of the present disclosure. The method includes steps S01 to S03.

In step S01, it is determined whether a measurement fed back by a distance sensor of a robot for cleaning a photovoltaic panel exceeds a first preset range. The method goes to step S02 in case of a positive determination, and repeats step S01 in case of a negative determination.

In step S02, it is determined that the robot deviates.

In step S03, a speed of a corresponding motor is adjusted based on the measurement fed back by the distance sensor, for automatic deviation correction.

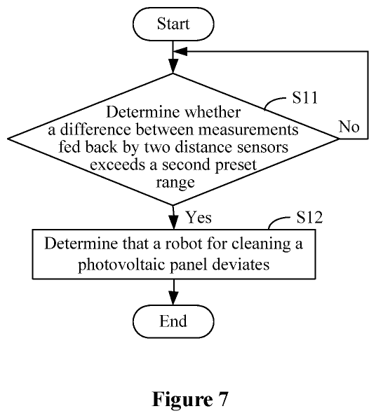

Corresponding to the embodiment as shown in FIG. 4, a method for controlling a robot for cleaning a photovoltaic panel is provided according to an embodiment of the present disclosure, as shown in FIG. 7. The method includes steps S11 and S12.

In step S11, it is determined whether a difference between measurements fed back by two distance sensors of the robot for cleaning the photovoltaic panel exceeds a second preset range. The method goes to step S12 in case of a positive determination, and repeats step S11 in case of a negative determination.

In step S12, it is determined that the robot deviates.

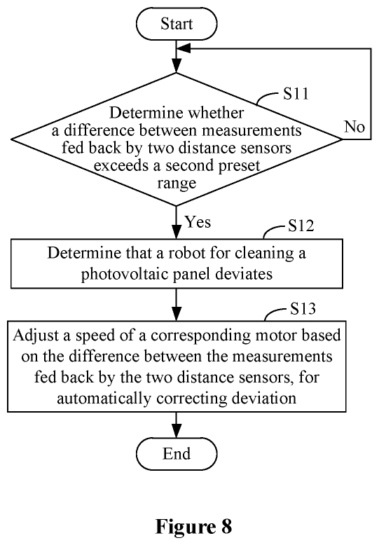

Optionally, the robot is driven by two independent motors at two sides. A left-side motor drives a travelling wheel that is on a left side of a chassis of the robot. A right-side motor drives a travelling wheel that is on a right side of the chassis of the robot. Correspondingly, as shown in FIG. 8, a method for controlling a robot for cleaning a photovoltaic panel is further provided according to an embodiment of the present disclosure. The method includes steps S11 to S13.

In step S11, it is determined whether a difference between measurements fed back by two distance sensors of the robot for cleaning the photovoltaic panel exceeds a second preset range. The method goes to step S12 in case of a positive determination, and repeats step S11 in case of a negative determination.

In step S12, it is determined that the robot deviates.

In step S13, a speed of a corresponding motor is adjusted based on the difference between the measurements fed back by the two distance sensors, for automatic deviation correction.

The embodiments of the present disclosure are described in a progressive manner, and each embodiment places emphasis on the difference from other embodiments. Therefore, one embodiment can refer to other embodiments for the same or similar parts. Since the methods disclosed in the embodiments corresponds to the robots for cleaning the photovoltaic panel disclosed in the embodiments, the description of the methods is simple, and reference may be made to the relevant part of the robots.

According to the description of the disclosed embodiments, those skilled in the art can implement or use the present disclosure. Various modifications made to these embodiments may be obvious to those skilled in the art, and the general principle defined herein may be implemented in other embodiments without departing from the spirit or scope of the present disclosure. Therefore, the present disclosure is not limited to the embodiments described herein but confirms to a widest scope in accordance with principles and novel features disclosed in the present disclosure.

1. A robot for cleaning a photovoltaic panel, driven by a motor to travel along a left boarder and a right boarder of the photovoltaic panel, wherein:
the robot is provided with a first control unit and a distance sensor;
the distance sensor is installed on a sidewall of the robot, the distance sensor faces a sidewall of the photovoltaic panel, and the distance sensor is configured to measure a distance between the distance sensor and the sidewall of the photovoltaic panel; and
the first control unit is configured to determine that a measurement for the distance that is fed back by the distance sensor exceeds a first preset range, and determine that the robot deviates; and
wherein:
the sidewall of the robot is a left sidewall of the robot, and the sidewall of the photovoltaic panel is a left sidewall of the photovoltaic panel; or
the sidewall of the robot is a right sidewall of the robot, and the sidewall of the photovoltaic panel is a right sidewall of the photovoltaic panel.

2. The robot according to claim 1, wherein:
the motor comprises a left-side motor and a right-side motor that drive the robot independently, the left-side motor drives a travelling wheel at a left side of a chassis of the robot, and the right-side motor drives a travelling wheel at a right side of the chassis of the robot; and
the first control unit is further configured to adjust a speed of the right-side motor or the left-side motor based on the measurement fed back by the distance sensor, for automatically correcting deviation.

3. A robot for cleaning a photovoltaic panel, driven by a motor to travel along a left boarder and a right boarder of the photovoltaic panel, wherein:
the robot is provided with a second control unit and two distance sensors;
the two distance sensors are installed on a sidewall of the robot, the two distance sensors face a sidewall of the photovoltaic panel, the two distance sensors are symmetrically arranged in a travelling direction of the robot, and each of the two distance sensors is configured to measure a distance between said distance sensor and the sidewall of the photovoltaic panel;
the second control unit is configured to determine that a difference between measurements for the distance that are fed back by the two distance sensors exceeds a second preset range, and determine that the robot deviates; and
wherein:
the sidewall of the robot is a left sidewall of the robot, and the sidewall of the photovoltaic panel is a left sidewall of the photovoltaic panel; or
the sidewall of the robot is a right sidewall of the robot, and the sidewall of the photovoltaic panel is a right sidewall of the photovoltaic panel.

4. The robot according to claim 3, wherein:
the motor comprises a left-side motor and a right-side motor that drive the robot independently, the left-side motor drives a travelling wheel at a left side of a chassis of the robot, and the right-side motor drives a travelling wheel at a right side of the chassis of the robot; and
the second control unit is further configured to adjust a speed of the right-side motor or the left-side motor based on the difference between the measurements fed back by the two distance sensors, for automatically correcting deviation.

5. The robot according to claim 2, wherein the speed of the right-side motor or the left-side motor is adjusted by using a subsection control algorithm.

6. The robot according to claim 4, wherein the speed of the right-side motor or the left-side motor is adjusted by using a subsection control algorithm.

7. The robot according to claim 1, wherein the distance sensor is an ultrasonic distance sensor or an infrared distance sensor.

8. The robot according to claim 3, wherein the distance sensor is an ultrasonic distance sensor or an infrared distance sensor.

9. A method for controlling a robot according to claim 1, comprising:
determining that the measurement fed back by the distance sensor exceeds the first preset range; and
determining that the robot deviates.

10. The method according to claim 9, wherein:
the motor comprises a left-side motor and a right-side motor that drive the robot independently, the left-side motor drives a travelling wheel at a left side of a chassis of the robot, and the right-side motor drives a travelling wheel at a right side of the chassis of the robot; and
after determining that the robot deviates, the method further comprises:
adjusting the speed of the right-side motor or the left-side motor based on the measurement fed back by the distance sensor, for automatically correcting deviation.

11. A method for controlling the robot according to claim 3, comprising:
determining that the difference between the measurements fed back by the two distance sensors exceeds the second preset range; and
determining that the robot deviates.

12. The method according to claim 11, wherein:
the motor comprises a left-side motor and a right-side motor that drive the robot independently, the left-side motor drives a travelling wheel at a left side of a chassis of the robot, and the right-side motor drives a travelling wheel at a right side of the chassis of the robot; and
after determining that the robot deviates, the method further comprises:
adjusting the speed of the right-side motor or the left-side motor based on the difference between the measurements fed back by the two distance sensors, for automatically correcting deviation.
